(19) United States
(12) Patent Application Publication
(10) Pub. No.: US 2025/0356502 A1
(43) Pub. Date: Nov. 20, 2025

(54) SYSTEMS AND METHODS FOR IDENTIFYING AN INTERACTIVE OBJECT

(71) Applicant: Universal City Studios LLC, Universal City, CA (US)

(72) Inventors: Wei Cheng Yeh, Orlando, FL (US); Katelyn Wyatt, Orlando, FL (US); McKenna Schwartz, Orlando, FL (US)

(21) Appl. No.: 19/208,203

(22) Filed: May 14, 2025

Related U.S. Application Data
(60) Provisional application No. 63/647,727, filed on May 15, 2024.

(51) Int. Cl. G06T 7/20; G06F 3/01; G06F 3/16; G06V 10/60

(52) U.S. Cl. CPC G06T 7/20; G06F 3/016; G06F 3/16; G06V 10/60

(57) ABSTRACT

An interactive object control system includes processing circuitry with one or more processors and memory storing instructions, that when executed by the processing circuitry cause the processing circuitry to input, into an interactive model, one or more respective characteristics of respective signals received at communication circuitry from respective interactive objects of multiple of interactive objects in an interactive environment. The instructions, when executed by the processing circuitry, cause the processing circuitry to select a best candidate interactive object from the multiple of interactive objects based on the one or more respective characteristics of the respective signals, track motion of the best candidate interactive object, and provide output instructions to one or more special effect components in the interactive environment to generate special effect outputs based on the motion of the best candidate interactive object.

### CROSS-REFERENCE TO RELATED APPLICATION

This application claims priority to and the benefit of U.S. Provisional Application No. 63/647,727, entitled “SYSTEMS AND METHODS FOR IDENTIFYING AN INTERACTIVE OBJECT” and filed May 15, 2024, which is incorporated by reference herein in its entirety for all purposes.

### BACKGROUND

This section is intended to introduce the reader to various aspects of art that may be related to various aspects of the present disclosure. This discussion is believed to be helpful in providing the reader with background information to facilitate a better understanding of the various aspects of the present disclosure. Accordingly, it should be noted that these statements are to be read in this light and not as admissions of prior art.

To improve guest experiences in an entertainment setting, the entertainment setting may often include objects (e.g., props or toys) that are interactive, provide special effects, or both. For example, the special effects may provide customized effects based on guests' experiences within the entertainment setting, as well as support a particular narrative in the entertainment setting. In certain interactive entertainment settings, guests may own or be associated with objects that interact with the interactive entertainment setting in various ways. In one example, a guest may wish to interact with the interactive entertainment setting using a handheld device (e.g., an object) to generate a particular special effect. However, such interactive entertainment settings are often crowded with multiple guests. Moreover, communicating wireless signals to identify objects within such interactive entertainment settings may be challenging when multiple guests are each carrying their own object.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below

In an embodiment, an interactive object control system includes processing circuitry with one or more processors and memory storing instructions that, when executed by the processing circuitry, cause the processing circuitry to input, into an interactive model, one or more respective characteristics of respective signals received at communication circuitry from respective interactive objects of multiple interactive objects in an interactive environment. The instructions, when executed by the processing circuitry, cause the processing circuitry to select a best candidate interactive object from the multiple interactive objects based on the one or more respective characteristics of the respective signals, track motion of the best candidate interactive object, and provide output instructions to one or more special effect components in the interactive environment to generate special effect outputs based on the motion of the best candidate interactive object.

In an embodiment, a method of operating an interactive object control system includes analyzing, using one or more processors, respective patterns in signal strength of respective signals received at communication circuitry from multiple interactive objects in an interactive environment. The method includes selecting, using the one or more processors, a best candidate interactive object from the multiple interactive objects based on the respective patterns in signal strength of the respective signals. The method also includes tracking, using the one or more processors, motion of the best candidate interactive object. The method further includes controlling, using the one or more processors, one or more special effect components in the interactive environment to generate special effect outputs based on the motion of the best candidate interactive object.

In an embodiment, an interactive object control system includes processing circuitry with one or more processors and memory storing instructions that, when executed by the processing circuitry, cause the processing circuitry to analyze respective patterns in signal strength of respective signals received at communication circuitry from multiple interactive objects in an interactive environment. The instructions, when executed by the processing circuitry, cause the processing circuitry to select a best candidate interactive object from the multiple interactive objects based on the respective patterns in signal strength of the respective signals, and also to provide output instructions to the best candidate interactive object to cause one or more output devices of the best candidate interactive object to provide a special effect output.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an embodiment of an interactive object control system, in accordance with present techniques;

FIG. 2 is a schematic illustration of hardware of an embodiment of the interactive object control system of FIG. 1, in accordance with present techniques;

FIG. 3 is a schematic illustration of an embodiment of a computing system, in accordance with present techniques;

FIG. 4 is a schematic illustration of an embodiment of the computing system, in accordance with present techniques; and

FIG. 5 is a flow diagram of an embodiment of a method for identifying a best candidate interactive object, in accordance with present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” “having,” and “based on” are intended to be inclusive and mean that there may be additional elements other than the listed elements.

Users (e.g., guests) in an interactive environment (e.g., an immersive experience or an entertainment setting) may enjoy carrying or wearing objects (e.g., props; guest objects; interactive objects), such as carrying handheld objects or wearing costume elements. The objects may be associated with a theme and may include a sword, wand, token, medallion, headgear, figurine, stuffed animal, clothing (e.g., hat), jewelry (e.g., necklace, bracelet, band), other portable object, or any combination thereof. Such objects may be utilized to facilitate interactions with the interactive environment. For example, certain movements of a toy sword may be detected as input that can initiate a special effect (e.g., display of imagery, such as animated characters; lighting; sounds; and/or haptic effects).

Such interactions in the interactive environment may generally be detected and controlled by a computing system (e.g., processing circuitry) that processes signals from one or more sensors (e.g., radiofrequency identification (RFID) readers) that read respective RFID tags of the objects to identify the objects inside the interactive environment. The computing system may control operation of surrounding features based on recognition of the objects, based on respective unique identifiers associated with the objects, based on recognition of respective patterns associated with the objects (e.g., movement or operation of the objects), and/or any combination thereof. In an embodiment, the one or more sensors and/or the computing system may be positioned external to the interactive environment, but control features within the interactive environment. While feedback (e.g., special effects) related to the objects may often be provided via components that are separate from the objects within the interactive environment, present embodiments may also operate to provide feedback (e.g., special effects) from within or on the objects, which may facilitate a deeper level of user immersion into the interactive environment.

As noted herein, the present embodiments relate to the objects that may include any suitable type of interactive objects in any suitable form, including the form of a sword, wand, token, medallion, headgear, figurine, stuffed animal, clothing (e.g., hat), jewelry (e.g., necklace, bracelet, band), and so forth. Additionally, the objects may include on-board communication circuitry (e.g., RFID tag) that, in operation, communicates object identification information and/or receives and sends wireless signals. Further, the objects may include one or more on-board light emitters and/or any other suitable hardware or circuitry components to enable feedback (e.g., display of special effects; haptic effects; audio effects) and interaction with the interactive environment.

Without the disclosed embodiments, individually addressing one user and/or one object within a crowded interactive environment with many users and many objects may be challenging. Additionally, without the disclosed embodiments, precisely locating one object and tracking the one object within a crowded interactive environment may be challenging. It may be desirable to identify the one object within the interactive environment that corresponds to a user profile, and also to track the movement of the one object within the interactive environment. Indeed, such identifying and tracking may facilitate unique interactions directly with the one object, such as in response to detected operations of the one object. For example, when a particular object within a group of similar objects is detected as performing a particular gesture, present embodiments may cause special effects to emit from the particular object and/or from an environmental component associated therewith (e.g., a special effect near the particular object or being pointed at by the particular object). Similarly, mere detection of individual objects within the interactive environment may enable present embodiments to direct respective interactions (e.g., special effects) to each of the objects individually. Such detection of individual objects may be based on object recognition, object motion within the interactive environment, and/or other identifying aspects. Further, such directed respective interactions may be based on profiles (e.g., profiles including preferred special effect types) identified as associated with the individual objects.

The disclosed interactive object techniques may permit user identification of a user and/or object identification of an object, as well as facilitate arbitrating between multiple objects containing communication circuitry (e.g., radiofrequency identification (RFID) tags) in an interactive environment. In an embodiment, an interactive object control system may identify or locate a particular object within a group of similar objects present in the interactive environment. Then, the interactive object control system may activate or direct special effects to the identified particular object and/or based on the identified particular object, for example, without necessarily activating or directing special effects to other objects in the group and/or based on the other objects in the group. Communicating object identification information from the particular object may facilitate identification of the particular object itself. However, to track the particular object within the interactive environment, the present techniques may permit dynamic identification of the particular object in a manner that is specific to a particular user interacting with the particular object at a particular time.

In certain interactive environments, multiple objects may be present. Distinctions between the multiple objects may be limited. Identification and tracking methods may be utilized to facilitate directing special effects to individual objects based on interactive object movement within the interactive environment. To accomplish this, the interactive object control system within the interactive environment may include a computing system that may receive object identification information (e.g., identification numbers) via signals (e.g., data) communicated over a particular radio frequency (RF) (e.g., radio frequency range). The computing system may identify a best candidate interactive object among the multiple objects based on one or more characteristics of the signals received from the multiple objects, such as signal strength of the signals (e.g., signal strength of the signals over time) that provide the object identification information. The computing system may utilize one or more identification models (e.g., trained models) to identify the best candidate interactive object among the multiple objects. For example, the one or more identification models may be trained on training data (e.g., a training data set) that may include signal strength of sample signals received from sample interactive objects over time as the sample interactive objects move through the interactive environment (e.g., at established or input locations; with established or input best candidate interactive object). More specifically, signal strength associated with the RFID tag's electronic product codes (EPC) or unique identifier (UID) of interactive objects may be correlated to respective distances from an associated RFID reader or sensor. The corresponding distance data may be utilized to identify a best candidate interactive object of the interactive objects for operating within a particular position. As described herein, the computing system may input the signals (or the signal strength of the signals over time) into the one or more identification models to identify the best candidate interactive object.

In an embodiment, the computing system may send special effect instructions or other operational instructions to a single object that was identified as the best candidate interactive object. The special effect instructions or other operational instructions may include instructions to activate one or more on-board light emitters, such as light emitting diodes (LEDs) of the object that emit light (e.g., light, such as infrared (IR) light, ultraviolet (UV) light, and/or visible light (e.g., in a detectable IR spectrum, UV spectrum, and/or visible spectrum)), and/or to activate one or more on-board haptic devices that provide haptic outputs, for example. In this way, the user may receive feedback that the object has been selected or identified as the best candidate interactive object.

In an embodiment, the computing system may utilize the light from the object to confirm (e.g., verify) the best candidate interactive object and/or to facilitate tagging the object in image data for tracking purposes. For example, the interactive object control system may include one or more cameras that provide the image data and also detect a lit object (e.g., the object with the illuminated one or more LEDs) of the multiple objects. In this way, the interactive object control system may effectively tag the lit object as a target object of interest in the image data, and confirm a position of the target object of interest in the image data and continue to track motion of the target object of interest via the image data. For example, the one or more cameras may track the motion of the target object of interest over time, and then send object movement data to the computing system, so that special effects commands are directed based on the motion of the target object of interest over time. As an example, the one or more cameras may track motion of the target object of interest via image analysis of the image data that may include reflected light from a detectable marker of the target object of interest.

However, it should be appreciated that the interactive control system may not track the motion of the best candidate interactive object via the one or more cameras. In an embodiment, the interactive control system may be devoid of any cameras that generate the image data of the best candidate interactive object or any objects. Instead, the interactive control system may utilize any suitable technique to track the motion of the best candidate interactive object (e.g., to identify gestures of the best candidate interactive object). For example, the computing system may track the motion of the best candidate interactive object based on the signals received from the best candidate interactive object at the one or more sensors. As an example, the computing system may track the motion of the best candidate interactive object based on a light detection and ranging (LIDAR) system, a Time of Flight (ToF) system, a Millimeter Wave (mmWave) system, or any combination thereof. Thus, in this way, a series of positions (e.g., motion and/or change in orientation) of the best candidate interactive object may be utilized to identify a gesture or pattern provided by the best candidate interactive object, which may then be interpreted as instructions for control of a separate feature (e.g., a special effect).

An object in accordance with present embodiments may be an interactive object (e.g., a toy) that can be used within the interactive environment to permit greater variability in experiences by enabling individualized output from user interactives. User interactives may include equipment (e.g., displays, lighting, speakers, and/or haptic devices) that may provide special effects or other types of output, including special effects or other types of output that can be directed to a specific user based on associating the best candidate interactive object with a user profile, for example. Specifically, user interactives may operate to detect object identification information associated with a particular object, associate the object identification information with a user profile, and provide an output based thereon (e.g., via communication with an effect system within the interactive environment). Linking a user profile to a user interactive may facilitate selecting special effects that are based upon information or data associated with the user profile.

The interactive environment may be part of an entertainment venue, such as an amusement park, an entertainment complex, a retail establishment, and so forth. The disclosed systems and methods may include at least one or more interactive environments in a themed area having a common theme. Further, the disclosed systems and methods may include additional or other interactive environments having different themes, but that are within the same entertainment venue. In some embodiments, the interactive environment may be a live show, where the users are in the audience and may be able to participate in the live show using their objects. When referring to an interactive environment, the interactive environment may include a certain area of the theme park where users can interact with interactive elements within the certain area. Further, an interactive environment may also include different locations that are geographically separated from one another or that are dispersed throughout the theme park. The interactive environment may also be in a remote location. For example, the user may be able to establish an interactive environment at their home or any other location via an electronic device associated with the user (e.g., user electronic device; home console) that may interact with the object.

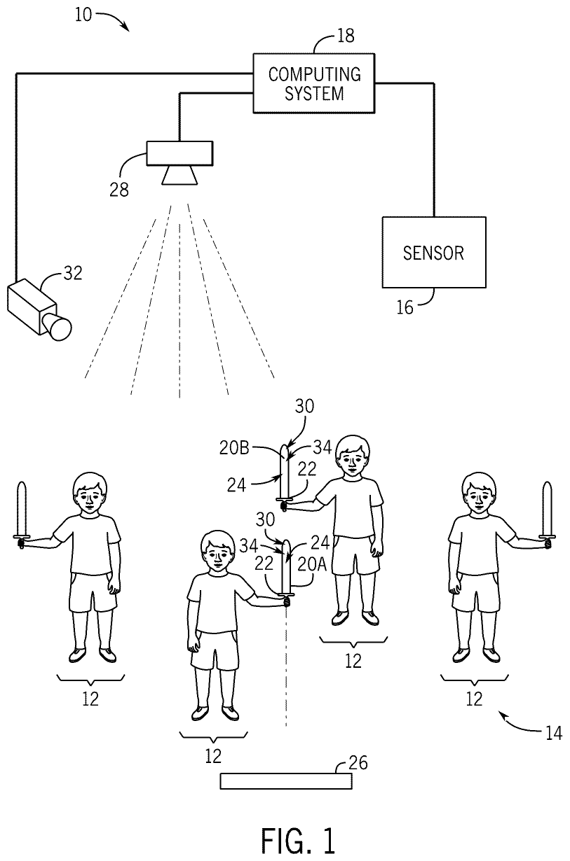

FIG. 1 is a schematic illustration of an embodiment of an interactive object control system 10, in accordance with present techniques. In one embodiment, the interactive object control system 10 may receive or detect interactive object identification information, which may include a unique device identification number from one or more interactive objects 20 in an interactive environment 14. The interactive environment 14 may include an area within a range for communication with one or more sensors 16 (e.g., radiofrequency identification (RFID) readers) of the interactive object control system 10. In one embodiment, the object identification information may be based on a unique identification code stored within a communication circuitry 24 (e.g., RFID tag) on or in a housing 22 of the one or more interactive objects 20, and the unique identification code may be transmitted to the interactive object control system 10 (e.g., read by the one or more sensors 16 of the interactive object control system 10).

As illustrated, users 12 may interact with the interactive object control system 10. Additionally, the one or more sensors 16 (which may be all or a part of a detection subsystem having one or more sensors and associated control circuitry) may detect one or more signals transmitted (e.g., via radio waves) from the one or more interactive objects 20. To control operations of the one or more sensors 16, as well as to perform various signal processing routines resulting from the detection processes, the interactive object control system 10 may also include a computing system 18 (e.g., processing system; electronic controller). The computing system 18 may be directly or communicatively coupled to the one or more sensors 16. As illustrated, the interactive object control system 10 may include the one or more interactive objects 20 (illustrated as handheld objects) that each include the housing 22, which may support the communication circuitry 24.

As discussed here, the communication circuitry 24 may actively or passively communicate certain object identification information of a respective interactive object of the one or more interactive objects 20 to the one or more sensors 16 in the interactive environment 14. In an embodiment, the communication circuitry 24 may include a RFID tag. In this way, the communication circuitry 24 may communicate the object identification information of the respective interactive object of the one or more interactive objects 20 to the one or more sensors 16 (implemented as receivers or RFID readers or any other suitable communication circuitry) of the interactive environment 14, which may subsequently communicate the object identification information to the computing system 18 of the interactive object control system 10. Generally, the communication circuitry 24 may enable wireless communication of the object identification information between respective hardware of the respective interactive object of the one or more interactive objects 20 and respective hardware of the interactive object control system 10 so that the object identification information that relates to one or both of a user profile and an object profile may be dynamically updated and used to generate personalized commands sent to the respective interactive object of the one or more interactive objects 20 and/or the interactive environment 14 from the computing system 18.

In an embodiment, the one or more sensors 16 may receive identification information (e.g., identification numbers) and/or positional information based on communication with the communication circuitry 24 of the one or more interactive objects 20 within the interactive environment 14. The positional information may include signal strength of the signals received from the communication circuitry 24 of the one or more interactive objects 20. In particular, the positional information may include the signal strength of the signals over time. In order to provide interactive experiences to the users 12, the computing system 18 may evaluate the signal strength of the signals over time to select a best candidate interactive object of the one or more interactive objects 20, as the signal strength over time indicates relative position (e.g., each of the one or more interactive objects 20 relative to the one or more sensors 16 and/or an interactive feature 26, such as a display surface). For example, to select the best candidate interactive object to use to trigger the interactive feature 26 (e.g., a gesture of the best candidate interactive object to initiate change to the interactive feature 26), it may be desirable to choose the best candidate interactive object as the interactive object 20 that is closest to the interactive feature 26 for a period of time (e.g., within a threshold range for more than a threshold time), which may be indicated by the signal strength of the signals over time. However, appropriate (e.g., accurate) selection of the best candidate interactive object may be more complex, as it may be desirable to choose the best candidate interactive object as the interactive object 20 based on other patterns or features in the signal strength over time.

Accordingly, in an embodiment, the computing system 18 may generate and/or access one or more identification models. Further, the computing system 18 may input the signals (or characteristics of the signals, such as the signal strength of the signals over time) into the one or more identification models to identify the best candidate interactive object. The one or more identification models may be machine learning or artificial intelligence (AI) models and may be trained on training data.

In an embodiment, such as during availability of particular known examples that correlate to future predictions, supervised AI/machine learning may be implemented. In supervised Al/machine learning, the mathematical model of a set of data may contain both the inputs and the desired outputs. This data may be referred to as “training data” and may be essentially a set of training examples. Each training example may have one or more inputs and the desired output, also known as a supervisory signal. Through iterative optimization of an objective function, supervised learning algorithms may learn a function that can be used to predict the output associated with new inputs. An optimal function may allow the algorithm to correctly determine the output for inputs that were not a part of the training data. An algorithm that improves the accuracy of its outputs or predictions over time may be said to have learned to perform that task.

Additionally and/or alternatively, in some situations, it may be beneficial to utilize unsupervised learning (e.g., when particular output types are not known). Unsupervised learning algorithms may take a set of data that contains only inputs and find structure in the data, such as grouping or clustering of data points. The algorithms, therefore, may learn from test data that has not been labeled, classified, or categorized. Instead of responding to feedback, unsupervised learning algorithms may identify commonalities in the data and react based on the presence or absence of such commonalities in each new piece of data. In any case, AI (e.g., machine learning) may be used to identify the best candidate interactive object to provide dynamic selection of the best candidate interactive object in order to provide interactive experiences as the users 12 travel through the interactive environment 14.

In an embodiment, the object identification information and/or the positional information may then be used to select the best candidate interactive object of the one or more interactive objects 20. The best candidate interactive object may include the particular interactive object of the one or more interactive objects 20 that is likely to perform or to have performed a gesture proximate to the interactive feature 26. In an embodiment, the best candidate interactive object of the one or more interactive objects 20 may be selected based on the respective received signal strength of the respective signals from the one or more interactive objects 20 (e.g., the best candidate interactive object of the one or more interactive objects 20 has a strongest signal strength and/or certain patterns of signal strength over time, such as increasing signal strength over time; via the one or more identification models), user profile (e.g., the best candidate interactive object of the one or more interactive objects 20 is associated with a user of a particular age and/or a particular height), or any other selection criteria, or any combination thereof (e.g., the best candidate interactive object of the one or more interactive objects 20 has the strongest signal strength among all child users in a particular age range). That is, the best candidate interactive object of the one or more interactive objects 20 may be based on one or more factors, changes to the factors, changes to thresholds associated with the factors (e.g., signal strength above a threshold level, such as for a period of time), and the like. In any case, once the best candidate interactive object of the one or more interactive objects 20 is identified, the computing system 18 may track motion of the best candidate interactive object and then instruct special effects based on the motion of the best candidate interactive object. The motion of the best candidate interactive object may be tracked via any suitable techniques, as described in more detail herein.

In an embodiment, the computing system 18 may send special effect instructions or other operational instructions to a single object that was identified as the best candidate interactive object. The special effect instructions or other operational instructions may include instructions to activate one or more on-board object emitters 30 (e.g., light emitters), such as light emitting diodes (LEDs) of the object that emit light (e.g., such as IR light, UV light, and/or visible light), and/or to activate one or more on-board haptic devices that provide haptic outputs, for example. In this way, the user may receive feedback that the interactive object has been selected or identified as the best candidate interactive object.

In an embodiment, the computing system 18 may utilize the light from the interactive object 20 to confirm (e.g., verify) the best candidate interactive object and/or to facilitate tagging the interactive object 20 in image data for tracking purposes. For example, the interactive object control system 10 may include one or more cameras 32 (e.g., capable of detecting light, such as IR light, UV light, and/or visible light). Thus, the one or more cameras 32 may provide the image data and also detect a lit object (e.g., the interactive object with the illuminated one or more object emitters 30) of the multiple objects. In this way, the interactive object control system 10 may effectively tag the lit object as a target object of interest in the image data, and confirm a position of the target object of interest in the image data and continue to track motion of the target object of interest via the image data. For example, this may confirm presence of the best candidate interactive object, and thereafter the one or more cameras 32 may track the motion of the best candidate interactive object as the target object of interest over time, and then send object movement data to the computing system 18, so that special effects commands are directed based on the motion of the target object of interest over time.

In an embodiment, the computing system 18 may send a signal addressed to the best candidate interactive object of the one or more interactive objects 20 to activate the one or more object emitters 30 of the best candidate interactive object of the one or more interactive objects 20 (e.g., on-board LEDs or speakers of the one or more interactive objects 20) to emit light, sound, or some other detectable emission. Such an emission from the best candidate interactive object of the one or more interactive objects 20 can then be detected to confirm location and identity thereof. As a specific example, the computing system 18 may emit a signal addressed to the best candidate interactive object of the one or more interactive objects 20 (e.g., by controlling the signal to activate an associated RFID tag of the best candidate interactive object). The best candidate interactive object of the one or more interactive objects 20 (e.g., the RFID tag of the best candidate interactive object of the one or more interactive objects 20) may receive the signal and automatically activate the one or more object emitters 30 of the best candidate interactive object of the one or more interactive objects 20 to display light (e.g., light, such as IR light, UV light, and/or visible light), sound, or any suitable emission effect that may be used for identification and/or tracking. In an embodiment, the communication circuitry 24 of the best candidate interactive object of the one or more interactive objects 20 may send a signal to activate the one or more object emitters 30 of the best candidate interactive object of the one or more interactive objects 20. The interactive object control system 10 may then confirm the presence of, confirm the position of, and/or otherwise identify the best candidate interactive object of the one or more interactive objects 20 because it will be the only interactive object of the one or more interactive objects 20 providing the emission (e.g., the only interactive object of the one or more interactive objects 20 with illuminated LEDs). It should be appreciated that the best candidate interactive object of the one or more interactive objects 20 may be triggered to provide only temporary or short emissions of a suitable duration (e.g., milliseconds, less than one second) to enable detection of the emissions by the one or more cameras 32, although the best candidate interactive object of the one or more interactive objects 20 may be triggered to provide longer continuous and/or repeated emissions (e.g., continuous or periodic while within the range of the one or more sensors 16 or for some other period of time) to facilitate detection of the emissions over time.

The computing system 18 may use the one or more cameras 32 to detect the best candidate interactive object of the one or more interactive objects 20 while the one or more object emitters 30 is providing a detectable emission (e.g., light, such as IR light, UV light, and/or visible light), and may tag the best candidate object (e.g., apply a tag to the best candidate object). At this point, the best candidate interactive object of the one or more interactive objects 20 may be considered a tagged or confirmed interactive object of the one or more interactive objects 20 that may also now be considered a target object of interest for tracking purposes. Such tagging may facilitate monitoring of movement (e.g., motion; movement or motion data) corresponding to the confirmed interactive object of the one or more interactive objects 20. Once tagged, the cameras 32 may continually monitor movement data of the confirmed interactive object of the one or more interactive objects 20 throughout the interactive environment 14. The one or more cameras 32 may send the movement data to the computing system 18. The computing system 18 may analyze the movement data and may send commands to activate special effects on the confirmed interactive object of the one or more interactive objects 20 and/or implement special effects within the interactive environment 14 based on the movement data for the confirmed interactive object of the one or more interactive objects 20. For example, the movement data associated with the confirmed interactive object of the one or more interactive objects 20 may correspond to a specific motion or gesture (e.g., arm waving; tracing a triangle in space) that causes the computing system 18 to transmit a signal that instructs a special effect (e.g., display, haptic, light, sound) from the confirmed interactive object of the one or more interactive objects 20 and/or in the interactive environment 14. The computing system 18 may process the movement data and compare the movement data to motion profiles stored in memory to select the special effect (e.g., a lookup table stored in a database in the memory of the computing system 18; one gesture such as the arm waving triggers one special effect, other gestures such as tracing the triangle in space triggers another special effect, and so on). Further, because the confirmed interactive object of the one or more interactive objects 20 has been associated with a user profile, certain aspects of the user profile may be used (e.g., to personalize special effects or personalized gesture detection thresholds).

In an embodiment, the one or more cameras 32 may track motion of the target object of interest via image analysis of the image data that may include reflected light (e.g., emitted by one or more emitters 28) from a detectable marker 34 of the target object of interest. This technique may be useful if any of the interactive objects 20 do not include the one or more object emitters 30. The one or more emitters 28 (which may be all or a part of an emission subsystem having one or more emission devices and associated control circuitry) may emit one or more wavelengths of electromagnetic radiation (e.g., light, such as IR light, UV light, and/or visible light). In one embodiment, the one or more emitters 28 may emit light within any suitable IR range that corresponds to a retroreflector range of the detectable markers 34 of the interactive objects 20 (e.g., 800 nanometer [nm]-1100 nm). The one or more emitters 28 may be multi-frequency light emitters and may emit light over different and/or multiple IR ranges (e.g., 800 nm-850 nm, 900 nm-1100 nm), which may facilitate detection of multiple interactive objects 20. The detectable markers 34 may be retroreflectors that filter light over different bands (e.g., of the IR spectrum), such that only certain frequencies may be reflected back in a detectable form based on the range. For example, a first interactive object 20A may communicate light filtered over an IR range of 800-850 nm and a second interactive object 20B (e.g., an additional interactive object) may communicate light filtered over an IR range of 900-1100 nm.

A first set or type of the one or more interactive objects 20 (e.g., certain models or versions, which may have a first set of features, such as absence of light emitters and/or haptic devices) may include respective detectable markers 34 that have a first retroreflector range (e.g., 800 nm-850 nm), while a second set of type of the one or more interactive objects 20 (e.g., other models or versions, which may have a second set of features, such as light emitters and/or haptic devices) may include respective detectable markers 34 that have a second retroreflective range (e.g., 900 nm-1100 nm), and so forth. Indeed, in some embodiments, the one or more interactive objects 20 may include multiple interactive objects (e.g., some of the first set or type, and some of the second set or type). The different ranges may assist in identifying the one or more interactive objects 20, identifying features of the one or more interactive objects 20, and/or distinguishing the multiple interactive objects from one another. The interactive object control system 10 may use this information to carry out appropriate further interactive steps based on the features of the one or more interactive objects 20 (e.g., the multiple interactive objects in a group). For example, as discussed in more detail herein, the interactive object control system 10 may proceed to instruct illumination of light emitters on a best candidate interactive object that is expected to be of the first set or type of the one or more interactive objects 20 that may include the light emitters, but may not do so if the best candidate interactive object is expected to be of the second set or type of the one or more interactive objects 20 that is devoid of the light emitters (instead, the interactive object control system 10 may proceed to track the best candidate interactive object, such as via reflected light from the detectable marker 34, without further steps to confirm or to tag the best candidate interactive object).

However, it should be appreciated that the interactive object control system 10 may not track the motion of the best candidate interactive object via the one or more cameras 32. In an embodiment, the interactive object control system 10 may be devoid of any cameras that generate the image data of the best candidate interactive object or any interactive objects. Instead, the interactive object control system 10 may utilize any suitable technique to track the motion of the best candidate interactive object (e.g., to identify gestures of the best candidate interactive object). For example, the computing system 18 may track the motion of the best candidate interactive object based on the signals received from the best candidate interactive object at the one or more sensors 16. As an example, the computing system 18 may track the motion of the best candidate interactive object based on a light detection and ranging (LIDAR) system, a Time of Flight (ToF) system, a Millimeter Wave (mmWave) system, or any combination thereof.

As generally disclosed herein, the detection of an interactive object of the one or more interactive objects 20 may be controlled by the computing system 18, which may also drive the one or more sensors 16. The activation may be indiscriminate, such that the one or more sensor 16 continuously emit electromagnetic radiation of a particular wavelength or frequency that corresponds to the communication circuitry 24 (e.g., to trigger return of the object identification information from the communication circuitry 24). Any interactive object of the one or more interactive objects 20 positioned within the interactive environment 14 and within range of the one or more sensors 16 may be activated to emit a signal indicating the object identification information (e.g., identification number) of that interactive object of the one or more interactive objects 20 to the one or more of the sensors 16 dispersed throughout the interactive environment 14.

As noted herein, the one or more interactive objects 20 may include multiple interactive objects. In such cases, when tracking the multiple interactive objects in the interactive environment 14, and particularly wherein two or more of the multiple interactive objects are close together and performing gestures that are intended to trigger special effects as part of an interactive experience, it may be difficult to distinguish between the multiple interactive objects. However, in such cases and during operation, each interactive object of the multiple interactive objects may be activated to present a unique identifier (e.g., identification number) to facilitate distinguishing between the multiple interactive objects. Further, in an embodiment, the activation of the multiple interactive objects may be selective. Specifically, the computing system 18 may process the object identification information transmitted from the multiple interactive objects via the respective communication circuitry 24 of the multiple interactive objects. Further, upon receiving the object identification information, the computing system 18 may identify a particular interactive object of the multiple interactive objects as the best candidate interactive object of the multiple interactive objects (e.g., based on a signal strength over time). The computing system 18 may tag the particular interactive object of the multiple interactive objects, which may assist with subsequent motion tracking to isolate motions made by the particular interactive object of the multiple interactive objects even while the particular interactive object of the multiple interactive objects is surrounded by other interactive objects of the multiple interactive objects (of the one or more interactive objects 20). In this way, the computing system 18 may determine that the particular interactive object of the multiple interactive objects (of the one or more interactive objects 20) has performed a particular action (e.g., a gesture), despite other interactive objects of the multiple interactive objects (of the one or more interactive objects 20) being in the same vicinity. In an embodiment, the computing system 18 may enable or disable special effects on the particular interactive object of the one or more interactive objects 20 and/or in the interactive environment 14 based on the motions of the particular interactive object of the one or more interactive objects 20, as well as based on a particular narrative (e.g., theme) and/or based on the user profile, for example.

The one or more interactive objects 20 may include onboard power supplies. For example, some interactive objects of the one or more interactive objects 20 may include a Near-Field Communication (NFC) coil located in the interior of the some interactive objects of the one or more interactive objects 20. The NFC coil may facilitate charging and/or power boosting for the respective interactive object of the one or more interactive objects 20 by gaining charge via transmission of energy from an external device, such as an external devices associated with the user 12 (e.g. mobile phone, NFC charger, which may be implemented as a toy or wearable device). The external device may include a holster and/or holder for the some interactive objects of the one or more interactive objects 20 so that the some interactive objects of the one or more interactive objects 20 may continuously charge as the user 12 moves throughout the interactive environment 14. The some interactive objects of the one or more interactive objects 20 may also include a rechargeable energy vessel/source (e.g. battery, super capacitor, and so forth) that may buffer and store energy, such as energy from the one or more sensors 16 (e.g., RFID reader), an electronic device associated with the user 12 (e.g., user's electronic device), an accessory of the some interactive objects of the one or more interactive objects 20, and so forth. The rechargeable energy source may facilitate provision of effects (e.g., light emissions) even when power from an external power source is not present.

In an embodiment, the one or more interactive objects 20 may be recharged throughout the day if on display and/or not in use by the users 12. The charging methods for the one or more interactive objects 20, may include mid-range to long-range charging methods via charging over Ultra high frequency (UHF) radio frequencies and charging using near-field communication (NFC) methods (e.g., NFC coil located within the one or more interactive objects 20, near field device). It should be understood that any of the above charging methods may be implemented individually or in combination. Further, the discussed power harvesting techniques may be used to directly power on-board special effects of the one or more interactive objects 20 and/or may be used to charge a battery or power storage of the one or more interactive objects 20 that may power the special effects.

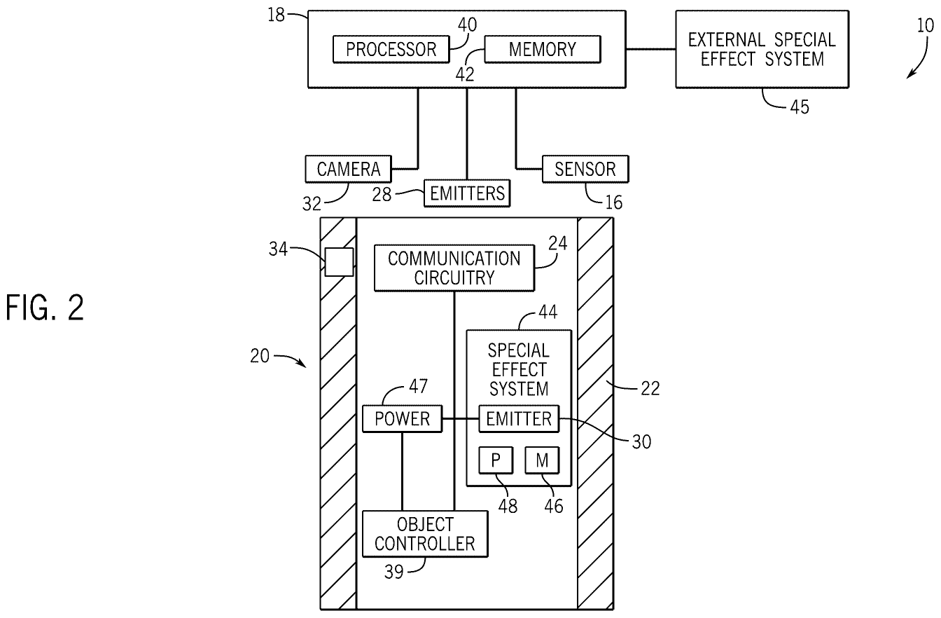

FIG. 2 is a schematic diagram of the interactive object control system 10 demonstrating communication between the one or more interactive objects 20 and various components of the interactive object control system 10 external to the one or more interactive objects 20. Disclosed techniques for detecting or locating the one or more interactive objects 20 as provided herein may utilize the one or more sensors 16 that provide positional data of the one or more interactive objects 20 (e.g., via signal strength over time).

In operation, the one or more sensors 16 may detect the one or more interactive objects 20 based on RF communications with the communication circuitry 24 of the one or more interactive objects 20. As noted herein, additionally or alternatively, other sensing methods may be utilized to detect the presence of the user 12 and/or the one or more interactive objects 20 in the interactive environment 14. The communication circuitry 24, which may include an RFID tag, may transmit electromagnetic radiation that indicates the object identification information to the one or more sensors 16 in the interactive environment 14.

A processor 40 of the computing system 18 may utilize this data to link a specific interactive object of the one or more interactive objects 20 to a specific user 12 in the interactive environment 14. The computing system 18 may send a targeted signal or instruction (e.g., a personalized special effect signal) to the communication circuitry 24 of the specific interactive object of the one or more interactive objects 20 based on the linkage of the user 12 to the specific interactive object of the one or more interactive objects 20. Moreover, the computing system 18 may update the user profile based on the user's interactions within the interactive environment 14. This targeted instruction or signal sent by the computing system 18 may be processed by an object controller 39 housed in the specific interactive object of the one or more interactive objects 20. The object controller 39 may activate a special effect system 44, which may be powered either passively (e.g., via power harvesting) or actively (e.g., by a power source) to emit a special effect that may be personalized to the user's profile and/or to the specific interactive object of the one or more interactive objects 20. Such a unique activation of the special effect from the specific interactive object of the one or more interactive objects 20 may facilitate confirmation of the identity of the user 12 and/or the specific interactive object of the one or more interactive objects 20 because it may be the only interactive object of the one or more interactive objects 20 among a group of interactive objects of the one or more interactive objects 20 providing the special effect. Further, the computing system 18 may provide instructions to control one or more special effect components that form part of an external special effect system 45 (e.g., off-board; physically separate from the one or more interactive objects 20) to provide one or more special effects in the interactive environment 14 based on actions (e.g., gestures) performed by the specific interactive object 20, and in some cases, such that the one or more special effects may be based on the linkage to the user 12 (e.g., themed in accordance with a theme preference designated in the user profile).

In the depicted embodiment, the communication circuitry 24 may emit a wireless signal that communicates object identification information via a RFID tag, a light signal (e.g., IR light signal, UV light signal, and/or visible light signal), or the like. The one or more sensors 16 may receive the object identification information and transmit the object identification information to the computing system 18. The object identification information may then be utilized by the processor 40 of the computing system 18. Specifically, for example, the computing system 18 may link a user profile to the interactive object of the one or more interactive objects 20 based on the object identification information. When trying to link the interactive object of the one or more interactive objects 20 to a specifically detected action performed (e.g., positioning, location, gesture) by one of a group of interactive objects of the one or more interactive objects 20, the computing system 18 may determine that the interactive object of the one or more interactive objects 20 is the best candidate interactive object within the interactive environment 14 based one or more factors, which may include relative received signal strength of multiple received signals. That is, the best candidate interactive object may correspond to a particular interactive object of the one or more interactive objects 20 emitting a signal having a highest received signal strength indicator (RSSI) value over time and/or certain patterns in the RSSI value over time, wherein the RSSI value indicates an amount of power present in a signal.

Confirming the best candidate interactive object of the one or more interactive objects 20 may also involve reference to a user profile associated with the signal. For example, the user profile may designate an address for an RFID tag of the best candidate interactive object of the one or more interactive objects 20, and the computing system 18 may initiate transmission of a responsive signal (e.g., a radio frequency signal) to this address to activate one or more object emitters 30 of the best candidate interactive object of the one or more interactive objects 20. Upon detection of emission from the one or more object emitters 30 by the one or more cameras 32, the interactive object control system 10 may tag the emitting interactive object of the one or more interactive objects 20 to confirm its identity and to facilitate further monitoring of the emitting interactive object of the one or more interactive objects 20 over time, so that unique effects (e.g., associated with the user profile of the emitting interactive object of the one or more interactive objects 20) may be correlated with the emitting interactive object 20 based actions performed thereby.

A memory 42 of the computing system 18 may store user profiles of multiple users 12 who have previously been matched to multiple interactive objects of the one or more interactive objects 20 within the interactive environment 14. The user profiles of an application associated with the interactive environment 14 may be updated based on activity of respective interactive objects of the one or more interactive objects 20 taking place throughout the interactive environment 14. The computing system 18 may update a user profile based on the user's experiences with their interactive object of the one or more interactive objects 20 within the area of the interactive environment 14. This may enable special effects to be differentiated based on the user profile throughout the interactive environment 14, and within multiple visits to the interactive environment 14. The user profile may also include information that is associated with the user 12, which may include user specific characteristics that are determined before first use of interactive object of the one or more interactive objects 20 and after first use of the interactive object of the one or more interactive objects 20. These characteristics may enable further differentiation of special effect commands based on the specific user 12. For example, if a user 12 requests a specific affiliation to a group or selects a specific category from a preset selection of categories, the user profile may be updated to display this information. The computing system 18 may send a special effect signal based on the user profile. This may include the output of a specific color LED, a sound effect, a haptic effect, a visual projection, or any combination thereof.

In an embodiment, the computing system 18 may send a haptic effect command to at least one interactive object of the one or more interactive objects 20, where the haptic effect command causes a haptic effect in the at least one interactive object of the one or more interactive objects 20 (e.g., via one or more haptic devices). By way of example, the haptic effect may create an experience of touch by applying vibration or other motion to the at least one interactive object of the one or more interactive objects 20. By creating a sense of touch or stimulating the touch sense, the user 12 may become more immersed into the interactive environment 14 since the stimulation may provide a more realistic experience. In an embodiment, the haptic effect command may also provide a particular intensity for the haptic effect, which may be adjusted for each of the at least one interactive object of the one or more interactive objects 20, for example, based on a height of each of the at least one interactive object of the one or more interactive objects 20 with respect to a floor of the interactive environment 14. This may facilitate providing effects designated as appropriate for children or adults based on an approximation associated with height.

The computing system 18 that receives and processes data from the one or more sensors 16 may include the one or more processors 40 and the memory 42. The processors 40, 48 and the memories 42, 46 may be generally referred to as “processing circuitry” and/or “processing system(s)” herein. By way of a specific but non-limiting example, the one or more processors 40, 48 may include one or more application specific integrated circuits (ASICs), one or more field programmable gate arrays (FPGAs), one or more general purpose processors, or any combination thereof. Additionally, the one or more memories 42, 46 may include volatile memory, such as random access memory (RAM), and/or non-volatile memory, such as read-only memory (ROM), optical drives, hard disc drives, or solid-state drives. In some embodiments, the computing system 18 may include and/or be at least a portion of a control system to coordinate operations of various amusement park features, such as an amusement park attraction and the interactive object control system 10. It should be understood that the subsystems of the interactive object control system 10 may also include similar features. In one example, the special effect system 44 may include processing capability via the processor 48 and the memory 46. Further, the object controller 39, may also include integral processing and memory components. Alternatively, the computing system 18 may control components of the interactive object 20.

The computing system 18 may include and/or be at least part of a controller (e.g., electronic controller). Further the computing system 18 may include and/or be at least part of a distributed decentralized network of one or more computing systems 18. The decentralized network of the one or more computing systems 18 may communicate with a park central controller and park central server. The decentralized network of the one or more computing systems 18 may facilitate reduction in processing time and processing power required for the one or more computing systems 18 dispersed throughout one or more interactive environments 14. The decentralized network of the one or more computing systems 18 may be configured to obtain user profiles by requesting the user profiles from a profile feed stored in the park central server. The user profile feed may include user accomplishments associated with the interactive object, user experience level, past user locations, and other user information. The one or more computing systems 18 may act as edge controllers that subscribe to a profile feed including multiple user profiles stored in a park central server and cache the feed to receive one or more user profiles contained in the feed.

In some embodiments, the interactive environment 14 may include one or more computing systems 18. The one or more computing systems 18 within the interactive environment 14 may communicate with each other through the use of a wireless mesh network (WMN) or other wireless and/or wired communication methods. The special effect commands may be generated by the computing system 18, a distributed node of the computing system 18, or by a dedicated local controller associated with the interactive environment 14 and communicated to the one or more interactive objects 20.

At least one interactive object of the one or more interactive objects 20 may include a power source 47, which may be a battery or a power-harvester, such as a radio frequency based power-harvesting antenna or an optical harvester. The power source 47, such as the harvested power, may be used to power one or more functions of the at least one interactive object of the one or more interactive objects 20, such as the special effect system 44. For example, the power source 47 may power multiple light emitting diodes with red, green, blue and white (RGBW) emitters.

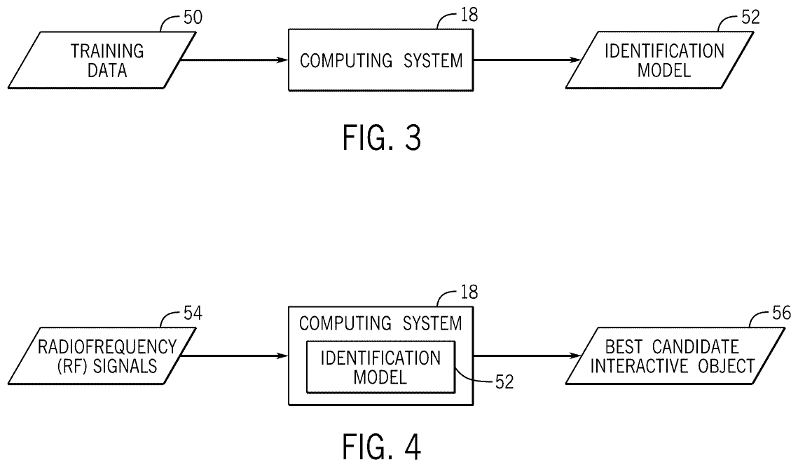

FIG. 3 is a schematic illustration of an embodiment of the computing system 18 that may receive training data 50 and generate one or more identification models 52 based on the training data 50, in accordance with present techniques. In an embodiment, training may be implemented via robotics (e.g., controlling one or more test interactive objects with one or more robotic arms to generate the training data 50). Additionally, FIG. 4 is a schematic illustration of an embodiment of the computing system 18 that may input radiofrequency (RF) signals 54 into the one or more identification models 52 to output an indicator of the best candidate interactive object 56. In this way, the computing system 18 may utilize Al/machine learning to identify the best candidate interactive object 56, including to identify the object identification information for the best candidate interactive object 56 for purposes of motion tracking and/or direct special effects.

As set forth herein and with reference to FIGS. 1-4, these techniques may be implemented in conjunction with confirmation via optical emission/detection (e.g., light emitted by the one or more object emitters 30 on the interactive objects 20 and/or light reflected by the detectable markers 34 on the interactive objects 20). However, advantageously the Al/machine learning techniques may be implemented to identify the best candidate interactive object 56 without confirmation via the optical emission/detection. For example, the Al/machine learning techniques may be implemented to identify the best candidate interactive object 56 without analysis of the image data from the camera 32 to detect light from the interactive objects 20. Indeed, the interactive object control system 10 may be devoid of the one or more emitters 28 and/or the one or more cameras 32, and/or the interactive objects 20 may be devoid of the one or more object emitters 30 and/or the one or more detectable markers 34. In an embodiment, the one or more emitters 28 and/or the one or more cameras 32, as well as the one or more object emitters 30 and/or the one or more detectable markers 34, may be utilized only for motion tracking once the best candidate interactive object is identified via the AI/machine learning techniques.

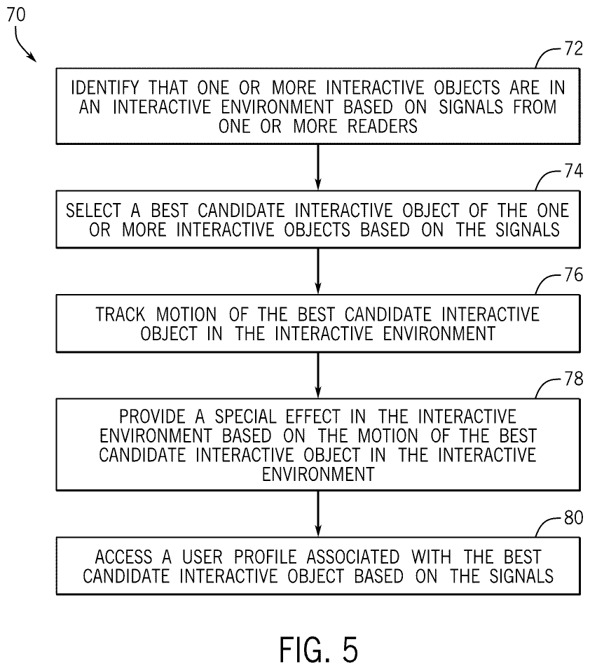

FIG. 5 is a flow diagram of a method 70 for identifying a best candidate interactive object, in accordance with present techniques. Generally, the method 70 may include a process for detecting that one or more interactive objects 20 are within the interactive environment 14, identifying the best candidate interactive object of the one or more interactive objects 20, and tracking the respective movement or actions of the best candidate interactive object of the one or more interactive objects 20. Identification of the best candidate interactive object of the one or more interactive objects 20 may be achieved through use of one or more sensors 16 (e.g., RFID readers) dispersed throughout the interactive environment 14, as well as inputting signals (or characteristics of the signals, such as signal strength over time) into one or more identification models (e.g., trained models).

The computing system 18, at block 72, may identify that one or more interactive objects 20 are within the interactive environment 14 based on signals (e.g., RF signals) received from the one or more sensors 16 (e.g., RFID readers). The communication circuitry 24 of at least one interactive object of the one or more interactive objects 20 may be triggered by the electromagnetic radiation from the one or more sensors 16, causing the communication circuitry 24 to emit a wireless signal that provides object identification information data to the one or more sensors 16. The wireless signal may also inherently have a signal strength, which may be utilized by present embodiments to facilitate identification of position data and/or a best candidate interactive object.

The computing system 18, at block 74, may select a best candidate interactive object of the one or more interactive objects 20 based on the signals (e.g., indicative of the unique identifier from the RFID tag and a signal strength provided via the communication circuitry 24). The best candidate interactive object may be selected based on the signal strength (e.g., indicative of estimated proximity to the one or more sensors 16), and in some cases the signal strength over time. For example, two interactive objects of the one or more interactive objects 20 may be within a communication range of a sensor 16 (e.g., RFID reader) during a period of time, but one of the two interactive objects of the one or more interactive objects 20 may be closer in proximity to the sensor 16 or may positioned to provide a respective signal strength within a threshold range (e.g., target range; having a maximum and minimum; non-zero) for more than a threshold period of time (e.g., demonstrates a dwell time within the threshold range). For example, to facilitate discussion, considering a scale of 1 to 10 (e.g., correlating to a range of RSSI values, such as −60 to −30), the one of the two interactive objects of the one or more interactive objects 20 may have a respective signal strength that remains within a threshold range of 3 to 6 for more than a threshold period of time of 3 seconds, while the other of the two interactive objects of the one or more interactive objects 20 may have a respective signal strength that is only within the threshold range of 3 to 6 for less than the threshold period of time or remains outside of the threshold range.

Notably, the closest interactive object may not necessarily be selected as the best candidate interactive object, as it may be desirable for the best candidate interactive object to be offset or set back from the interactive feature 26 (e.g., on a designated target provided on a ground in front of the interactive feature 26). Further, the best candidate interactive object may not necessarily be selected based on position alone, but instead signal strength (e.g., as a proxy for position) over time, including certain patterns in the signal strength over time (e.g., increasing, such as increasing at a particular rate over time and/or increasing over time to a target signal strength that corresponds to the designated target) and based on the one or more interactive models (e.g., trained models) to more accurately identify users intending to interact with the interactive feature 26 and/or properly positioned to interact with the interactive feature 26, for example. Further, the best candidate interactive object may be selected based on its signal strength over a period of time relative to respective signal strength of other interactive object(s) over the same period of time (e.g., two RF signals from two interactive objects may qualify or meet the threshold range over the threshold period of time, and the computing system 18, via the one or more interactive models, selects one as the best candidate interactive object).

The computing system 18, at block 76, may track motion of the best candidate interactive object in the interactive environment 14 (e.g., tracked motion that is associated with and/or assigned to the best candidate interactive object). As described herein, motion tracking may be accomplished in any of a variety of ways, including based on signal strength of the signals. In an embodiment, the motion tracking may be carried out via a light detection and ranging (LIDAR) system, a Time of Flight (ToF) system, a Millimeter Wave (mmWave) system, or any combination thereof. In an embodiment, confirmation of the best candidate interactive object and/or motion tracking may be carried out via optical emission/detection, such as via sending instructions to activate one or more object emitters 30 of the best candidate interactive object of the one or more interactive objects 20 based on a unique identifier of the best candidate interactive object of the one or more interactive objects 20 (e.g., the unique identifier obtained via communication with the communication circuitry 24). The instructions for activating the one or more object emitters 30 may be provided via a radio frequency signal addressed to activate a particular RFID tag of the best candidate interactive object of the one or more interactive objects 20. However, other activation mechanisms may be utilized in accordance with present embodiments.

The computing system 18, at block 78, may provide a special effect in the interactive environment 14 based on the motion of the best candidate interactive object (e.g., tracked motion that is associated with and/or assigned to the best candidate interactive object) in the interactive environment 14. For example, the computing system 18 may send additional signals to the best candidate interactive object of the one or more interactive objects 20 (e.g., the tracked interactive object) and/or components in the interactive environment 14 based on the motion data. For example, the computing system 18 may trigger light, sound, haptic effects, and/or other effects (e.g., display of imagery, such as animated characters) based on the motion data, the user profile, and so forth.

The computing system 18, at block 80, may access a user profile associated with the best candidate interactive object based on the signals (e.g., date or information encoded in the signals; indicative of the unique identifier from the RFID tag) received from the one or more sensors 16. The computing system 18 may query a database stored in a memory to determine a respective user profile and/or information for each of the one or more interactive objects 20 based on the signals. The respective user profile may include user past experiences, user preferences, user information, and the like. In this way, the computing system 18 may direct personalized special effects to the one or more interactive objects 20 based on the user profiles. The computing system 18 may update the respective user profile based on the motion tracked for or associated with the best candidate interactive object of the one or more interactive objects 20 throughout the interactive environment 14 (e.g., to mark achievements). As noted herein, the computing system 18 may communicate with an electronic device of the user, and in this way the updates may be reflected via the application of the electronic device for display of the performance statistics in real time to the user 12.

While certain examples include light emissions in IR range to facilitate discussion and illustrate various use cases, it should be appreciated that any suitable range(s) may be utilized to enable techniques disclosed herein. For example, any suitable light range(s) may be emitted by the emitters and object emitters, and any suitable range(s) may be detected by the sensors, cameras, and so forth. While only certain features of the invention have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ” it is intended that such elements are to be interpreted under 35 U.S.C. 112(f). However, for any claims containing elements designated in any other manner, it is intended that such elements are not to be interpreted under 35 U.S.C. 112(f).

1. An interactive object control system, comprising:
processing circuitry comprising one or more processors; and
memory storing instructions, that when executed by the processing circuitry, cause the processing circuitry to:
input, into an interactive model, one or more respective characteristics of respective signals received at communication circuitry from a plurality of interactive objects in an interactive environment;
select a best candidate interactive object from the plurality of interactive objects based on the one or more respective characteristics of the respective signals;
track motion of the best candidate interactive object; and
provide output instructions to one or more special effect components in the interactive environment to generate special effect outputs based on the motion of the best candidate interactive object.

2. The interactive object control system of claim 1, wherein the one or more respective characteristics comprises signal strength over time.

3. The interactive object control system of claim 2, wherein the instructions, when executed by the processing circuitry, cause the processing circuitry to:
select the best candidate interactive object from the plurality of interactive objects based on a respective signal strength of a respective signal received at the communication circuitry from the best candidate interactive object being within a target range of signal strength for a threshold period of time.

4. The interactive object control system of claim 1, wherein the instructions, when executed by the processing circuitry, cause the processing circuitry to:
access respective profiles associated with the plurality of interactive objects; and
select the best candidate interactive object from the plurality of interactive objects based on the one or more respective characteristics of the respective signals and information stored in the respective profiles associated with the plurality of interactive objects.

5. The interactive object control system of claim 1, wherein the instructions, when executed by the processing circuitry, cause the processing circuitry to:
access a respective profile associated with the best candidate interactive object based on a respective unique identifier encoded in a respective signal received at the communication circuitry from the best candidate interactive object; and
provide the output instructions to the one or more special effect components in the interactive environment to generate the special effect outputs based on the motion of the best candidate interactive object and information in the respective profile associated with the best candidate interactive object.

6. The interactive object control system of claim 1, wherein the instructions, when executed by the processing circuitry, cause the processing circuitry to:
provide additional output instructions to the best candidate interactive object to cause a light emitter of the best candidate interactive object to emit light; and
confirm presence of the best candidate interactive object based on detection of the light by one or more cameras.

7. The interactive object control system of claim 6, wherein the light comprises infrared light.

8. The interactive object control system of claim 1, wherein the instructions, when executed by the processing circuitry, cause the processing circuitry to:
provide additional output instructions to the best candidate interactive object to cause a speaker of the best candidate interactive object to emit sound, a haptic device of the best candidate interactive object to output a haptic effect, or any combination thereof.

9. The interactive object control system of claim 1, wherein the instructions, when executed by the processing circuitry, cause the processing circuitry to:
track the motion of the best candidate interactive object based on the one or more respective characteristics of a respective signal received at the communication circuitry from the best candidate interactive object.

10. The interactive object control system of claim 1, wherein the instructions, when executed by the processing circuitry, cause the processing circuitry to:
provide additional output instructions to a light emitter to cause the light emitter to emit light; and
track the motion of the best candidate interactive object based on reflection of the light by the best candidate interactive object.

11. A method of operating an interactive object control system, the method comprising:
analyzing, using one or more processors, respective patterns in signal strength of respective signals received at communication circuitry from a plurality of interactive objects in an interactive environment;
selecting, using the one or more processors, a best candidate interactive object from the plurality of interactive objects based on the respective patterns in signal strength of the respective signals;
tracking, using the one or more processors, motion of the best candidate interactive object; and
controlling, using the one or more processors, one or more special effect components in the interactive environment to generate special effect outputs based on the motion of the best candidate interactive object.

12. The method of claim 11, comprising analyzing, using the one or more processors and an interactive model, the respective patterns in signal strength of the respective signals.

13. The method of claim 11, comprising selecting, using the one or more processors, the best candidate interactive object from the plurality of interactive objects in response to a respective pattern in signal strength of a respective signal received at the communication circuitry from the best candidate interactive object indicating an increase in signal strength over time.

14. The method of claim 11, comprising selecting, using the one or more processors, the best candidate interactive object from the plurality of interactive objects in response to a respective pattern in signal strength of a respective signal received at the communication circuitry from the best candidate interactive object indicating a target range of signal strength for a threshold period of time.

15. The method of claim 11, comprising controlling, in response to selecting the best candidate interactive object and using the one or more processors, the best candidate interactive object to cause a light emitter of the best candidate interactive object to emit infrared light.

16. The method of claim 11, comprising:
controlling, using the one or more processors, a light emitter to emit light; and
tracking, using the one or more processors, the motion of the best candidate interactive object based on reflection of the light by the best candidate interactive object.

17. An interactive object control system, comprising:
processing circuitry comprising one or more processors; and
memory storing instructions, that when executed by the processing circuitry, cause the processing circuitry to:
analyze respective patterns in signal strength of respective signals received at communication circuitry from a plurality of interactive objects in an interactive environment;
select a best candidate interactive object from the plurality of interactive objects based on the respective patterns in signal strength of the respective signals; and
provide output instructions to the best candidate interactive object to cause one or more output devices of the best candidate interactive object to provide a special effect output.

18. The interactive object control system of claim 17, comprising the best candidate interactive object, wherein the one or more output devices comprises a light emitter, a speaker, a haptic device, or any combination thereof.

19. The interactive object control system of claim 17, wherein the instructions, when executed by the processing circuitry, cause the processing circuitry to:
analyze the respective signal strength of the respective signals using a machine learning model trained on training data that includes respective sample signal strength of respective sample signals received from a plurality of sample interactive objects.

20. The interactive object control system of claim 17, wherein the instructions, when executed by the processing circuitry, cause the processing circuitry to:
track motion of the best candidate interactive object; and
provide additional output instructions to one or more special effect components in the interactive environment to generate one or more environment special effect outputs based on the motion of the best candidate interactive object.

21. The interactive object control system of claim 20, wherein the instructions, when executed by the processing circuitry, cause the processing circuitry to:
track the motion of the best candidate interactive object based on detection of light reflected by the best candidate interactive object.

22. The interactive object control system of claim 17, wherein the instructions, when executed by the processing circuitry, cause the processing circuitry to provide additional output instructions to the best candidate interactive object to cause a light emitter of the best candidate interactive object to emit infrared light.
